(19) United States
(12) Patent Application Publication
(10) Pub. No.: US 2011/0229237 A1
(43) Pub. Date: Sep. 22, 2011

(54) PRINTING APPARATUS AND METHOD FOR CONTROLLING THE SAME

(75) Inventor: Tomonori Hayashi, Kawasaki-shi (JP)

(73) Assignee: CANON KABUSHIKI KAISHA, Tokyo (JP)

(21) Appl. No.: 13/050,073

(22) Filed: Mar. 17, 2011

(30) Foreign Application Priority Data
Mar. 19, 2010 (JP) 2010-064319

(51) Int. Cl. B41J 11/44

(52) U.S. Cl. 400/76

(57) ABSTRACT

A printing apparatus includes an input unit, a holding unit, a printing unit, sheet stacking units, a storage unit, a sheet feeding unit, a detection unit, a determination unit, a request unit, a receiving unit, and a control unit. The sheet feeding unit feeds a sheet to be used by the printing unit when executing a specific print job, from a specific sheet stacking unit stored in the storage unit in association with attribute information included in the specific print job. When the determination unit determines that a remaining number of sheets stacked in the specific sheet stacking unit will run short by finishing the specific print job, the requesting unit requests an operator's instruction for changing sheet attribute information included in the specific print job. The control unit changes the sheet attribute information per the operator's instruction.

### BACKGROUND OF THE INVENTION

1. Field of the Invention

The present invention relates to a printing apparatus and a method for controlling the printing apparatus.

2. Description of the Related Art

A conventional printing apparatus is known to perform print processing based on a print job input from a host computer, etc.

A conventional technique is known to perform print processing by using a sheet having an attribute (type and size) set in the print job.

With this technique, however, when the printing apparatus is not provided with the sheet having the attribute set in the print job, print processing cannot be executed.

With a technique discussed in Japanese Patent Application Laid-Open No. 2008-40573, a host computer acquires in advance the sheet attribute provided in a printing apparatus and, when the acquired attribute does not agree with the sheet attribute set in a print job, does not transmit the print job. The technique discussed in Japanese Patent Application Laid-Open No. 2008-40573 can solve the problem that the host computer transmits the print job to the printing apparatus even when the printing apparatus is not provided with the sheet having the attribute set in the print job.

However, even when the printing apparatus is provided with the sheet having the attribute set in the print job, processing may be interrupted when starting the print job or during execution of the job.

For example, when a plurality of print jobs is in advance input in the printing apparatus, there may be a case where all of sheets having a certain attribute are used by an input print job and sheets having the attribute set in subsequent print jobs may run out. In this case, subsequent print jobs cannot be executed.

### SUMMARY OF THE INVENTION

The present invention is directed to providing an improved printing apparatus and a method for controlling the printing apparatus.

The present invention is also directed to preventing print processing from being interrupted when starting or during execution of a specific print job.

According to an aspect of the present invention, a printing apparatus includes an input unit, a holding unit, a printing unit, a plurality of sheet stacking units, a storage unit, a sheet feeding unit, a detection unit, a determination unit, a request unit, a receiving unit, and a control unit. The input unit inputs a print job including attribute information of a sheet to be used for print processing. The holding unit holds the print job input by the input unit. The printing unit executes the print job held by the holding unit to perform print processing for the sheet. The plurality of sheet stacking units stack sheets to be used for the print processing. The storage unit stores each of the plurality of sheet stacking units in association with attribute information of sheets stacked in the plurality of sheet stacking units. The sheet feeding unit feeds a sheet to be used by the printing unit when executing a specific print job included in a plurality of print jobs held by the holding unit, from a specific sheet stacking unit stored in the storage unit in association with the attribute information included in the specific print job. The detection unit detects a remaining number of sheets stacked in each of the plurality of sheet stacking units. The determination unit determines whether the remaining number of sheets stacked in the specific sheet stacking unit will run short by finishing the specific print job based on an amount of sheets stacked in the specific sheet stacking unit to be used by the specific print job and other print jobs preceding the specific print job. The request unit requests, when the determination unit determines that the remaining number of sheets stacked in the specific sheet stacking unit will run short by finishing the specific print job, an operator's instruction for changing the sheet attribute information included in the specific print job to other sheet attribute information. The receiving unit receives an operator's instruction for changing the sheet attribute information included in the specific print job to other sheet attribute information. The control unit performs, when the receiving unit receives the operator's instruction, control for changing the sheet attribute information included in the specific print job stored in the storage unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a print processing system.

FIG. 2 illustrates library information for usable sheets.

FIG. 3 is a block diagram illustrating a configuration of a multi function peripheral (MFP).

FIG. 4 is a sectional view illustrating the configuration of the MFP.

FIG. 5 illustrates a printer driver setting screen.

FIG. 6 illustrates a screen displayed when a PROPERTY button in FIG. 5 is pressed.

FIG. 7 illustrates a screen displayed when a FINISH tab in FIG. 6 is selected.

FIG. 8 illustrates a screen displayed when a FEED tab in FIG. 6 tab is selected.

FIG. 9 illustrates a screen displayed when the FEED tab in FIG. 6 tab is selected.

FIG. 10 illustrates data structure of a print job.

FIG. 11 illustrates an exemplary print job list.

FIG. 12 illustrates paper feed tray information.

FIG. 13 is a flow chart illustrating processing for updating the print job list.

FIG. 14 illustrates a print job list.

FIG. 15 illustrates an alternative sheet setting screen.

FIG. 16 is a flow chart illustrating processing for setting an alternative sheet.

FIG. 17 illustrates a print job list.

FIG. 18 is a flow chart illustrating processing of a print job.

FIG. 19 illustrates a print job list.

### DESCRIPTION OF THE EMBODIMENTS

Various exemplary embodiments, features, and aspects of the invention will be described in detail below with reference to the drawings.

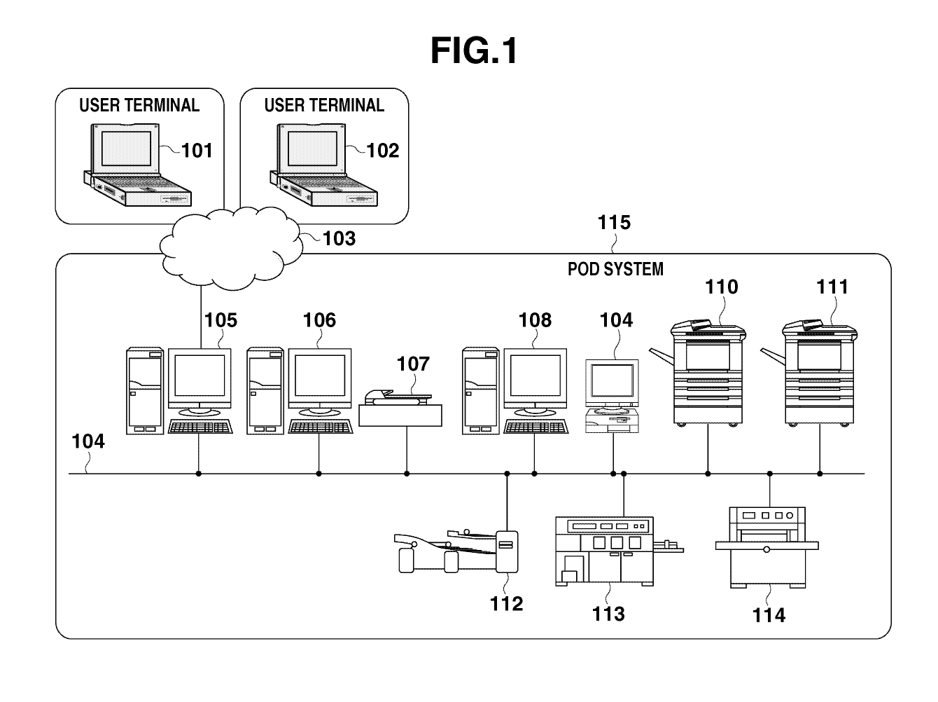

FIG. 1 illustrates a print processing system according to a first exemplary embodiment. The printing system illustrated in FIG. 1 includes one or more user terminals (user terminals 101 and 102 in the present exemplary embodiment) and a print on demand (POD) system 115 connected via the Internet 103.

A person can place an order for a print service to the POD system 115 by using the user terminal 101 or 102.

In the POD system 115, an order-receiving server 105 receives an order for a print service from the user terminal 101 or 102 via the Internet 103, and receives print job data as a print service from the user terminal 101 or 102. The print job data refers to a series of print jobs arranged from data of a plurality of pages created by using specific application software on the user terminal 101 or 102. The print job data includes data created by using application software operating on the user terminal 101 or 102 and additional setting information for specifying an output manner of the data in the POD system. The output manner denotes, for example, bookbinding type, color mode, and sheet type. The order-receiving server 105 manages the print job data received from the user terminal 101 or 102 based on the identification (ID) number issued by the order-receiving server 105. The order-receiving server 105 is provided with Web server functions, and a function to transmit display data to be displayed on the web browser to a web browser operating on the user terminals 101 and 102 via the Internet 103.

A file server 106 is used by the order-receiving server 105 to store and manage print job data received via the Internet 103.

The file server 106 stores library information of sheets usable for a multi function peripheral (MFP) 110 and a MFP 111. (Hereinafter, the library information of sheets is referred to as sheet library information.)

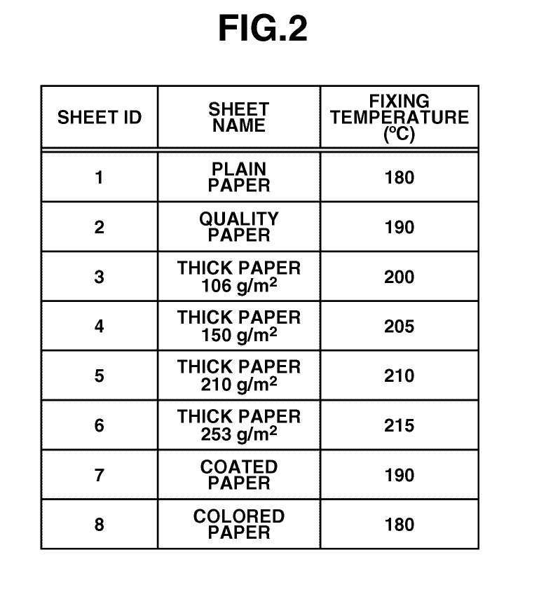

The sheet library information is as illustrated in a table in FIG. 2. Although the sheet library information in FIG. 2 stores eight different sheet types in tabular form, more number (for example, hundreds) of sheet types may be stored therein. Each of the eight sheet types is assigned a unique sheet ID. With the sheet ID, a sheet type is identified. The file server 106 can transmit the sheet library information to the MFPs 110 and 111. Upon reception of the sheet library information, the MFPs 110 and 111 make various settings for operating the printing apparatus based on the sheet library information. The table in FIG. 2 defines a fixing temperature for each sheet type. The fixing temperature refers to a temperature at which a toner image on a sheet is thermally fixed by the fixing device 608 (described below). The fixing temperature for the fixing processing is set for each sheet type. The sheet library information enables the MFPs 110 and 111 to apply the fixing processing to the sheet at a suitable fixing temperature according to the sheet type. Although the fixing temperature is associated with the sheet type in FIG. 2, information other than the fixing temperature may be added to the sheet library information. For example, a transfer voltage applied to the transfer drum 605 may be added to the sheet library information.

The print server 108 stores image data generated by a scanner 107 and a scanning device which scans a document on the MFPs 110 and 111. The print server 108 also corrects the image data generated by scanning, specifically, it corrects deviation in the scanning direction and eliminates noise (black points). The print server 108 also combines a plurality of pieces of print job data stored in the file server 106 with image data generated through scanning by the scanner 107.

The print server 108, a client personal computer (PC) 109, the scanner 107, and the MFPs 110 and 111 are connected via a network 104 such as a local area network (LAN) to enable data and control command transmission/reception therebetween.

Referring to the print processing system illustrated in FIG. 1, a paper folding machine 112 has a function to fold a plurality of sheets output by the MFPs 110 and 111.

A case binding device 113 has a function to paste a cover sheet to a plurality of sheets to be bound and perform book binding.

A sheet cutting device 114 cuts the plurality of sheets, with the cover pasted thereon, bound by the case binding device 113.

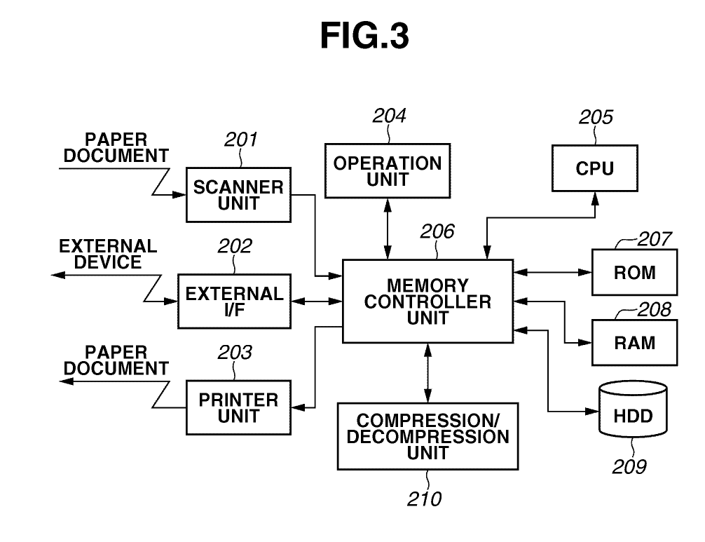

The MFPs 110 and 111 will be described below. FIG. 3 is a block diagram illustrating a configuration of the MFPs 110 and 111 (hereinafter referred to as MFP 110/111). The MFP 110/111 according to the present exemplary embodiment is provided with a storage device such as a hard disk (HD) 209 for storing a plurality of pieces of job data. The MFP 110/111 has a copy function to input job data from a scanner unit 201, store it in the hard disk 209, and print it on a printer unit 203. The MFP 110/111 also has a print function to input job data via an external interface (I/F) 202, store it in the hard disk 209, and print it on the printer unit 203.

As illustrated in FIG. 3, the MFP 110/111 according to the present exemplary embodiment includes the scanner unit 201 for scanning an image such as a paper document and processing relevant image data. The MFP 110/111 further includes the external I/F 202 for transmitting and receiving image data to/from external apparatuses, and the printer unit 203 for forming an image on a sheet based on job data stored in the hard disk 209.

The MFP 110/111 further includes an operation unit 204 which enables an operator of the MFP 110/111 to select various processing functions of the MFP 110/111 and issue various instructions.

The MFP 110/111 further includes a central processing unit (CPU) 205 and operates based on a program loaded into a read-only memory (ROM) 207. The ROM 207 of the MFP 110/111 stores a program for interpreting page description language (PDL) code data received from an external apparatus (for example, a client PC 109) by the external I/F 202. The ROM 207 further stores a program for converting the PDL code data into raster image data. These programs are executed by the CPU 205.

A memory controller unit 206 of the MFP 110/111 further controls access to the ROM 207, a random access memory (RAM) 208, and the hard disk 209.

The ROM 207 prestores a program for initializing various functions of the MFP 110/111, font information, and so on. The RAM 208, a readable/writable memory, stores image data received from the scanner unit 201 and the external I/F 202 via the memory controller unit 206, as well as various programs and setting information. The hard disk 209 is amass storage device for storing image data compressed by a compression/decompression unit 210.

The compression/decompression unit 210 compresses and decompresses image data stored in the RAM 208 and the hard disk 209 by using various compression methods such as JBIG and JPEG.

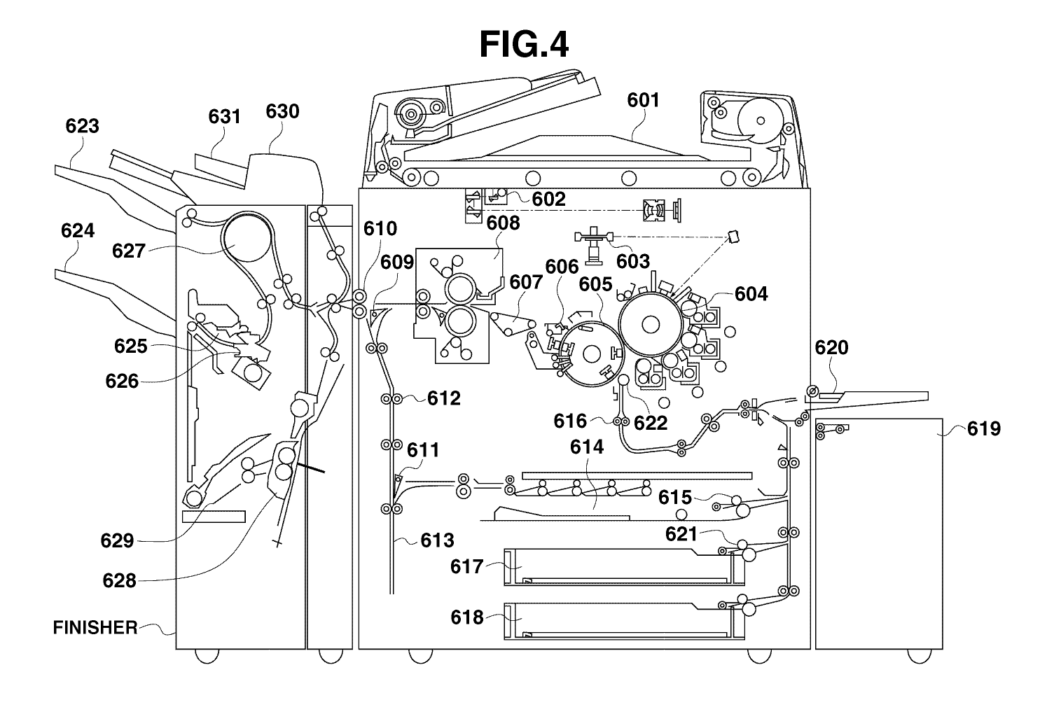

FIG. 4 is a sectional view illustrating a configuration of the MFP 110/111. Referring to FIG. 4, an automatic document feeder (ADF) 601 sequentially separates a sheet from a document sheet bundle set on a stacking surface of a document tray. The ADF 601 conveys the document sheet from the sheet bundle onto a document mounting glass to scan a document by using a scanner 602. The scanner 602 scans an image on the document mounted on the document mounting glass and converts the scanned image into relevant image data by using a charge-coupled device (CCD). A rotating polygon mirror 603 inputs light, such as laser light, modulated by the image data to a reflection mirror. The reflection mirror reflects the scanning light onto a photosensitive drum 604.

A latent image formed on the photosensitive drum 604 by the reflected scanning light is developed by toner to form a toner image. Then, the toner image is transferred onto a sheet material stuck onto the transfer drum 605. The MFP performs this series of image forming processes for each of yellow (Y), magenta (M), cyan (C), and black (K) color toner, thus forming a colored image.

Upon completion of four image forming processes, the sheet on the transfer drum 605 is separated by a separation nail 606 and then conveyed to a fixing device 608 by a pre-fixing conveyance unit 607. The fixing device 608 includes roller pairs and belts and a heat source such as a halogen heater. The fixing device 608 applies heat and pressure to the toner on the sheet on which the toner image is transferred.

A sheet discharge flapper 609 is configured to swing centering on its swinging axis to regulate the sheet conveyance direction. For example, when the sheet discharge flapper 609 swings in the clockwise direction, the sheet is conveyed straight and then discharged to the outside of the printing apparatus by a discharge roller pair 610. On the other hand, when forming an image on both sides of the sheet, the sheet discharge flapper 609 swings in the counterclockwise direction and the sheet conveyance path is changed to the downward direction. In this case, the sheet is conveyed to the two-sided conveyance unit.

The two-sided conveyance unit includes an inverting flapper 611, an inverting roller pair 612, an inverting guide 613, and a two-sided tray 614. The inverting flapper 611 is configured to swing centering on its swinging axis to regulate the sheet conveyance direction. First, the inverting flapper 611 swings in the counterclockwise direction, and then the sheet is fed to the inverting guide 613 by the inverting roller pair 612. The inverting roller pair 612 once stops with the trailing edge of the sheet supported by the inverting roller pair 612. Then, the inverting flapper 611 swings in the clockwise direction. Then, the inverting roller pair 612 rotates in the opposite direction to convey the sheet on a switchback basis, i.e., the sheet is conveyed with its leading and trailing edges counterchanged. Then, the sheet is guided toward the two-sided tray 614.

The sheet is once stacked on the two-sided tray 614 and then fed to a registration roller pair 616 by a re-feed roller pair 615. In this case, the sheet is fed such that the side opposite to the side having undergone the first-side transfer process faces the photosensitive drum 604. Then, a second-side image is formed in a similar way to the above-mentioned first-side transfer process. After undergoing the fixing process, the sheet having images formed on both side is discharged to the outside of the printing apparatus.

The feed conveyance unit includes sheet stacking units (a sheet cassette A 617, a sheet cassette B 618, a paper deck 619, and a manual feed tray 620), a sheet feeding roller pair 621, and the registration roller pair 616.

The sheet cassette A 617, the sheet cassette B 618, the manual feed tray 620, and the paper deck 619 store sheets of various sizes and various types. Each of the sheet cassette A 617, the sheet cassette B 618, the paper deck 619, and the manual feed tray 620 is provided with the sheet feeding roller pair 621 for feeding sheets one by one. Specifically, stacked sheets are sequentially fed by a pickup roller. Double feed is prevented by a separation roller disposed facing the sheet feeding roller pair 621. Sheets are fed one by one to a conveyance guide.

Driving force for rotating the separation roller in a direction opposite to the sheet conveyance direction is input to the separation roller via a torque limiter (not illustrated). While only one sheet enters a nip portion formed between the separation roller and the feed rollers 621, the separation roller is rotated in the sheet conveyance direction by the sheet. When double feed occurs, the separation roller rotates in a direction opposite to the sheet conveyance direction. As a result, double-fed sheets are returned and only the uppermost sheet is fed.

Being guided by the conveyance guide, the sheet is conveyed to the resist roller pair 616 by a plurality of conveyance rollers. At this timing, since the resist roller pair 616 is in a stop and the leading end of the sheet comes in contact with the nip portion formed by the resist roller pair 616, the sheet forms a loop and skew is corrected. Then, in synchronization with the timing of toner image formation on the photosensitive drum 604 at an image forming portion, the resist roller pair 616 starts rotation to convey the sheet.

The sheet fed by the resist roller pair 616 is then electrostatistically adsorbed on the surface of the transfer drum 605 by the adsorption roller 622.

The sheet discharged from the fixing device 608 of the printer unit 203 enters an on-line finisher unit (when connected). The on-line finisher unit is provided with a sample tray 623 and a stack tray 624 to which sheets are discharged. The sample tray 623 and the stack tray 624 are selected depending on the job type and the number of sheets discharged.

When the staple mode is set for a job to be output (hereinafter referred to as target job), the on-line finisher unit is controlled to discharge sheets onto the stack tray 624. Specifically, before a sheet is discharged onto the stack tray 624, sheets are sequentially stored in a processing tray 625 in the on-line finisher unit for each job. Then, sheets are bundled by a stapler 626 on the processing tray 625 to form a sheet bundle, and the sheet bundle is discharged onto the stack tray 624.

A puncher 627 for punching two (or three) holes for filing is provided on a path between the processing tray 625 and the stack tray 624 to perform perforation depending on the job type. For example, when a user sets punching via the operation unit as a sheet processing setting for the target job, the on-line finisher unit performs the following operation. Specifically, the sheet for the target job is subjected to punching by the puncher 627, guided through the internal mechanism, and then discharged onto anyone discharge tray such as the stack tray 624 and the sample tray 623.

A saddle stitcher 628 performs bookbinding processing for creating a booklet such as a pamphlet. Specifically, the saddle stitcher 628 binds two center portions of the sheet and makes a roller catch the central portion of the sheet to center-fold the sheet. The sheet that has undergone bookbinding processing by the saddle stitcher 628 is discharged onto a booklet tray 629. Whether sheet processing operation such as bookbinding processing can be performed by the saddle stitcher 628 is also determined based on sheet processing set for the target job by the user, as mentioned above.

An inserter 630 is used to discharge a sheet set in an insertion tray 631 onto any one discharge tray such as the stack tray 624 and the sample tray 623 without sending it into the MFP. This enables inserting a sheet set in the inserter 630 between sheets (sheets printed by the printer unit 203) fed to the on-line finisher unit. The user sets on the insertion tray 631 of the inserter 630 sheets to be inserted with face up. The pickup roller sequentially feeds the sheets from the uppermost sheet.

Therefore, a sheet fed from the inserter 630 is discharged as it is (face down) onto the stack tray 624 or the sample tray 623. When feeding the sheet to the saddle stitcher 628, the orientation of the sheet face is unified by once feeding the sheet to the puncher 627 and then conveying it on a switchback basis. Whether sheet processing operation such as sheet insertion processing can be performed by the inserter 630 is also determined based on sheet processing set for the target job by the user, as mentioned above.

The following describes processing by the operator of the POD system 115 for transmitting a print job from the client PC 109 to the MFP 110 or 111 according to an order received by the order-receiving server 105.

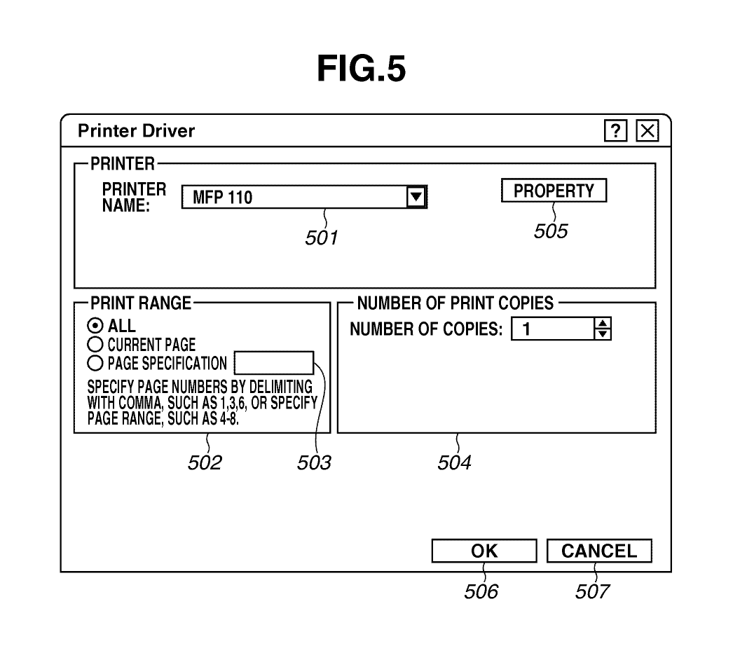

FIG. 5 illustrates a setting screen for a printer driver operating on the client PC 109. When the operator is creating a document by using application software such as document creation application, the client PC 109 activates the printer driver to display the setting screen in FIG. 5 on its display screen. The printer driver, a device driver for controlling the MFP 110 or 111, is software operating on the client PC 109. The client PC 109 activates the printer driver to generate a print job to be transmitted to the MFP 110 or 111.

In the setting screen in FIG. 5, an operator (worker) of the client PC 109 operates a printer name selection box 501 by using a pointing device (not illustrated). This operation enables the printer driver to select either the MFP 110 or 111 as a destination of the print job to be transmitted from the client PC 109. Referring to FIG. 5, the client PC 109 selects the MFP 110. The worker of the client PC 109 operates a printing range selection box 502 by using a pointing device. This operation determines a desired range in the document generated by the application as a range to be printed by the MFP 110. When the worker selects “ALL”, the printer driver recognizes that all of the document pages generated by the application are subjected to printing. When the worker selects “CURRENT PAGE”, the printer driver recognizes that the page currently displayed on the screen of the present client PC, out of a plurality of document pages generated by the application, is subjected to printing. When the worker selects “PAGE SPECIFICATION”, the printer driver recognizes that the page input in the editing box 503, out of a plurality of document pages generated by the application, is subjected to printing. The printer driver recognizes the number of print copies input in a print-copy-number setting box 504 by the worker.

Upon completion of setting a print job to be transmitted to the MFP 110 via the printer driver, the worker of the client PC 109 presses the OK button 506 to start generation of the print job. To stop generation of the print job, the worker of the client PC 109 presses the CANCEL button 507.

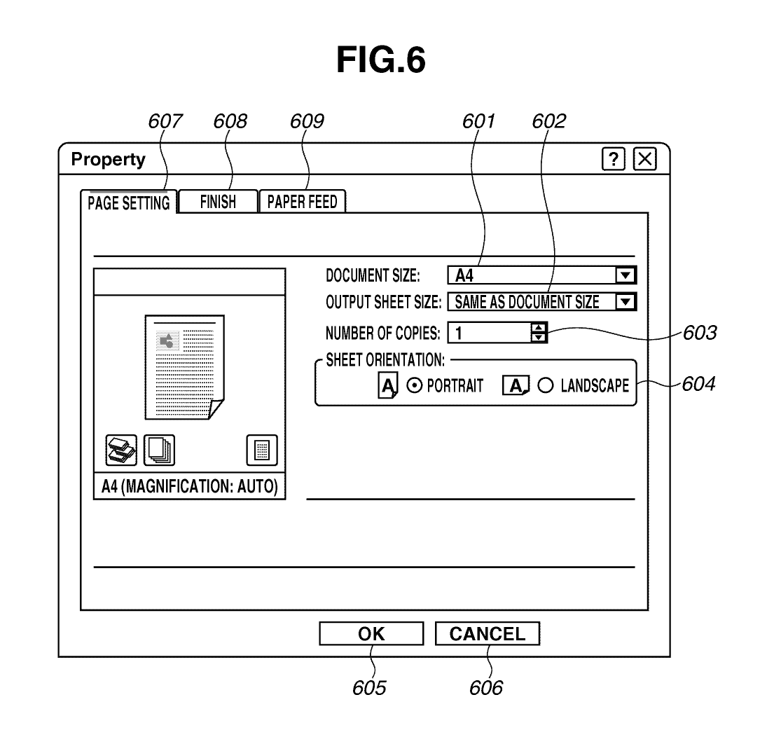

FIG. 6 illustrates a screen displayed when the worker presses the PROPERTY button 505 in the printer driver property setting screen in FIG. 5.

The worker of the client PC 109 operates a document size selection box 601 by using a pointing device (not illustrated). This operation enables the printer driver to select the size of each page in the application data currently active on the client PC 109. Since the document size is regularly specified in a document generated by application data, this document size is selected automatically. When the worker selects “SAME AS DOCUMENT SIZE” in an output paper size selection box 602, the printer driver selects the A4 size as the sheet size used for print processing (output processing) by the MFP 110, In addition to “SAME AS DOCUMENT SIZE”, the worker can select “A3 SIZE”, “B5 SIZE”, and other desired sheet sizes as the output paper size. In this case, however, since a size different from the document size is selected, the printer driver generates a print job while changing the magnification. The printer driver also sets in the print job the number of copies input when the worker inputs a desired number of print copies in a copy-number selection box 603. The printer driver inputs a print orientation selected in a print orientation specification box 604 by the worker.

When the worker selects the OK button 655, the CPU 205 applies the values input in the document size selection box 651, the output paper size selection box 652, the copy-number selection box 653, and the print orientation specification box 654. When the worker selects the CANCEL button 656, the CPU 205 restores predetermined initial settings without applying the values input in the document size selection box 651, the output paper size selection box 652, the copy-number selection box 653, and the print orientation specification box 654.

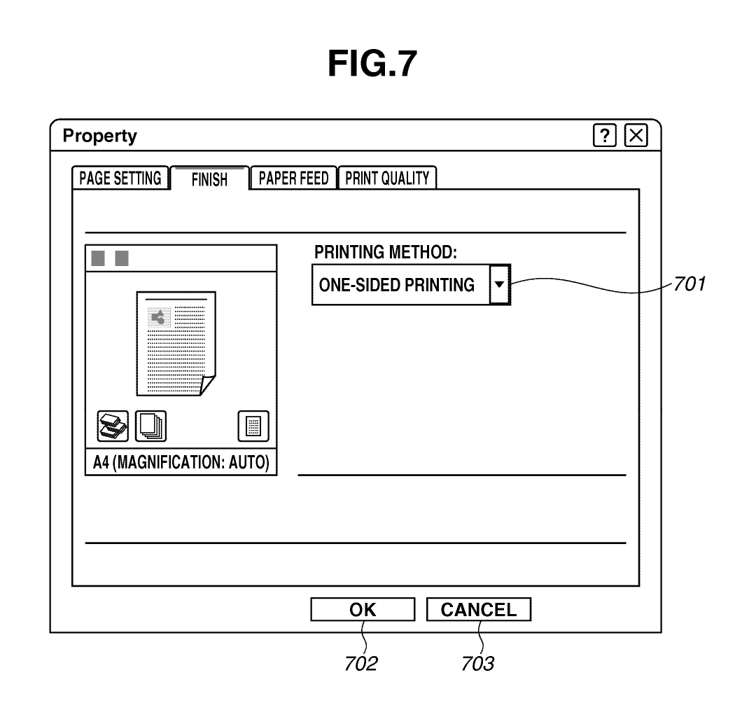

FIG. 7 illustrates a screen displayed when the finish tab 658 is selected in the printer driver property setting screen in FIG. 6.

The worker of the client PC 109 operates the printing method selection box 701 by using a pointing device (not illustrated). This operation enables the printer driver to select a printing method used by the MFP 110 to perform print processing of the print job generated from the application data. Printing methods include “ONE-SIDED PRINTING” for printing only on one side of sheet, “TWO-SIDED PRINTING” for printing on both sides of sheet, and “BOOKBINDING PRINTING” by using the saddle stitcher 628.

When the worker selects the OK button 702, the CPU 205 applies the value input in the printing method selection box 701. When the worker selects the CANCEL button 703, the CPU 205 restores predetermined initial settings without applying the value input in the printing method selection box 701.

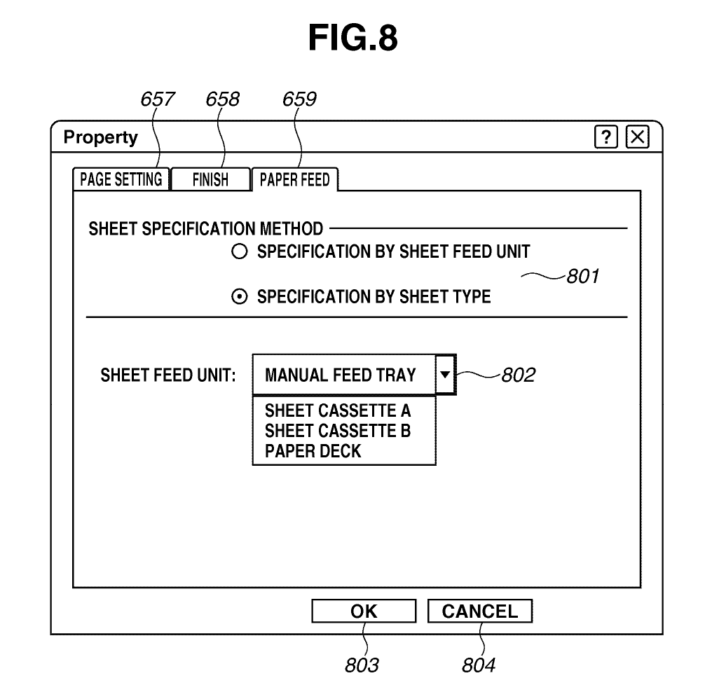

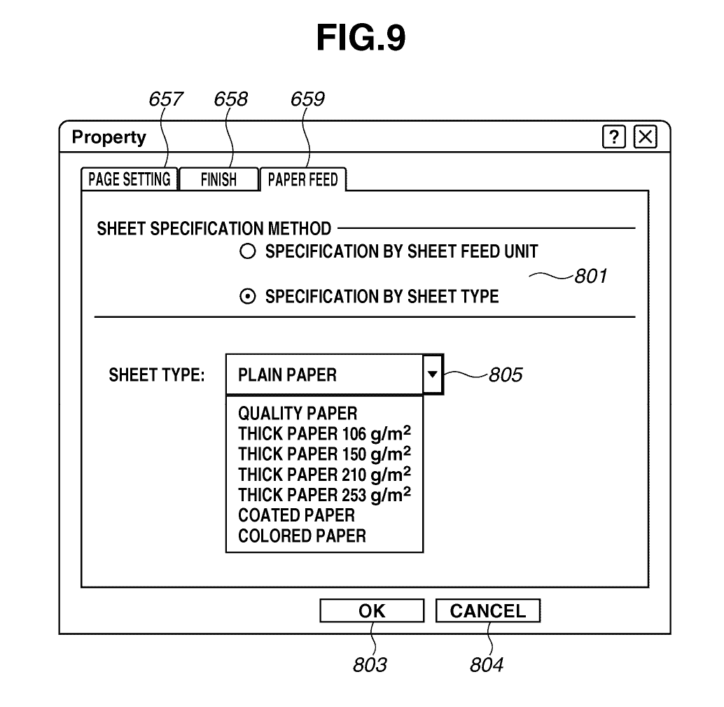

FIGS. 8 and 9 illustrates a screen displayed when the FEED tab 659 is selected in the printer driver property setting screen in FIG. 6.

The worker of the client PC 109 operates the sheet specification method selection button 801 by using a pointing device (not illustrated). This operation enables the printer driver, when the worker selects the “SPECIFICATION BY SHEET FEED UNIT” button, to set the sheet feed unit selected from the sheet feed unit selection box 802 to the print job.

When the worker selects the “SPECIFICATION BY SHEET TYPE” button, the printer driver sets the sheet type selected from the sheet type selection box 805 to the print job.

When the worker selects the OK button 803, the CPU 205 applies the value input in the sheet feed unit selection box 802 or the sheet type selection box 805. When the worker selects the CANCEL button 804, the CPU 205 restores predetermined initial settings without applying the value input in the sheet feed unit selection box 802 or the sheet type selection box 805.

When setting in the printer driver property setting screens in FIGS. 6 to 9 is completed (when the OK button 655, the OK button 702, and the OK button 803 are accepted), the processing returns to the printer driver setting screen in FIG. 5. When the OK button 506 is accepted in the printer driver setting screen in FIG. 5, the client PC 109 combines the settings in the property setting screen with the application data to generate one print job. Then, the client PC 109 transmits the print job to the MFP 110.

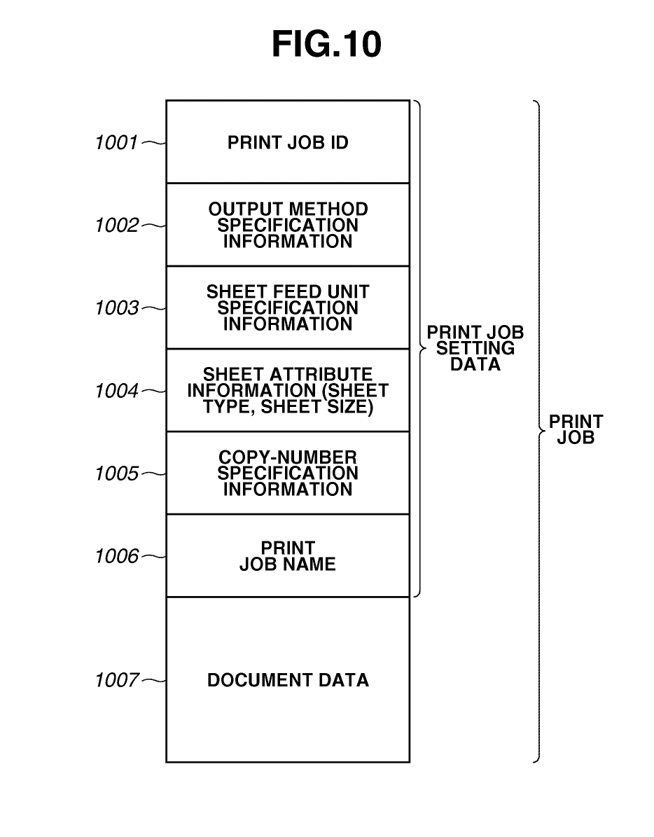

An exemplary data structure of a print job is illustrated in FIG. 10. FIG. 10 illustrates a data structure of a print job transmitted from the client PC 109 to the MFP 110.

Referring to FIG. 10, a print job ID 1001 is a unique ID given to each print job. Any print job can be specified when the client PC 109 transmits the print job to the MFP 110 or 111, etc. via the network 104. Output method specification information 1002 specifies the output method. The printing method selected in the printing method selection box 701 is identified with this information. Sheet feed unit specification information 1003 specifies the sheet feed unit. The sheet feed unit selected in the sheet feed unit selection box 802 is identified with this information. Sheet attribute information 1004 includes the sheet size information for identifying the output paper size selected in the output paper size selection box 602 and the sheet type information selected in the sheet type selection box 805. Copy-number specification information 1005 specifies the number of print copies. The number of print copies input in the copy-number setting box 504 or the copy-number selection box 603 (the same value is input in each box) is identified with this information. A print job name 1006 is text data denoting a file name used to manage print job data by using the application. Document data 1007 is data of a document generated by the application operating on the client PC 109. The document data 1007 describes the number of pages included in the document.

Processing of a print job performed by the MFP 110 will be described below. The print job is transmitted from the client PC 109 to the MFP 110.

Upon reception of the print job from the client PC 109, a CPU 205 of the MFP 110 holds the received print job in a hard disk drive (HDD) 209 and manages it by using a print job list.

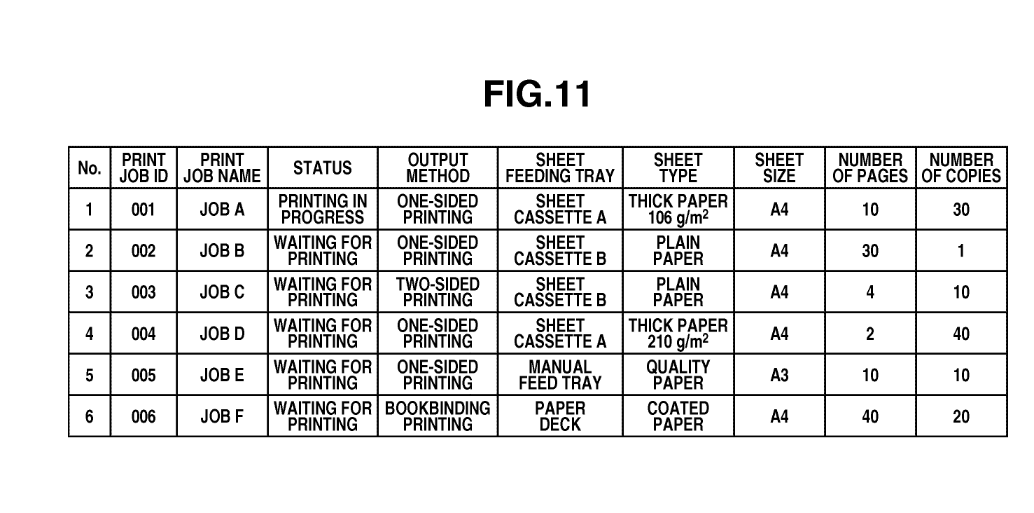

The print job list will be described below with reference to FIG. 11. FIG. 11 illustrates an exemplary print job list stored in the HDD 209. Referring to FIG. 11, “NO.” denotes the number of print jobs stored in the print job list, and the print job list stores six print jobs. “PRINT JOB ID” corresponds to the print job ID 1001 included in the print job setting data of each print job. “PRINT JOB ID” is an ID unique to each print job received by the MFP 110. “PRINT JOB NAME” corresponds to the print job name 1006 included in the print job setting data of each print job. “STATUS” is a processing status denoting whether the print job is under print processing (PRINTING IN PROGRESS) or waiting for print processing (WAITING FOR PRINTING). “OUTPUT METHOD” corresponds to the output method specification information 1002 included in the print job setting data of each print job. “OUTPUT METHOD” specifies the output method (ONE-SIDED PRINTING, TWO-SIDED PRINTING, PRINTING WITH BOOKBINDING) performed at the time of print processing for the received print job by the MFP 110. “SHEET TYPE” is included in the sheet attribute information 1004 included in the print job setting data of each print job. “SHEET TYPE” identifies the sheet type used by the print job. For example, any one of eight sheet types (PLAIN PAPER, QUALITY PAPER, THICK PAPER 106 g/m2, THICK PAPER 150 g/m2, THICK PAPER 210 g/m2, THICK PAPER 253 g/m2, COATED PAPER, and COLORED PAPER) is specified in a print job transmitted from the client PC 109 to the MFP 110. “SHEET SIZE” is included in the sheet attribute information 1004 included in the print job setting data of each print job. “SHEET SIZE” identifies the sheet size used by the print job. For example, any one of sheet sizes (A4, A5, B5, B4, LEGAL, or LETTER) is specified in a print job transmitted from the client PC 109 to the MFP 110. “NUMBER OF PAGES” denotes the number of document pages described in the document data 1007. “NUMBER OF COPIES” is included in the sheet attribute information 1004 included in the print job setting data of each print job. “NUMBER OF COPIES” specifies the number of print copies of the document data 1007 included in the print job.

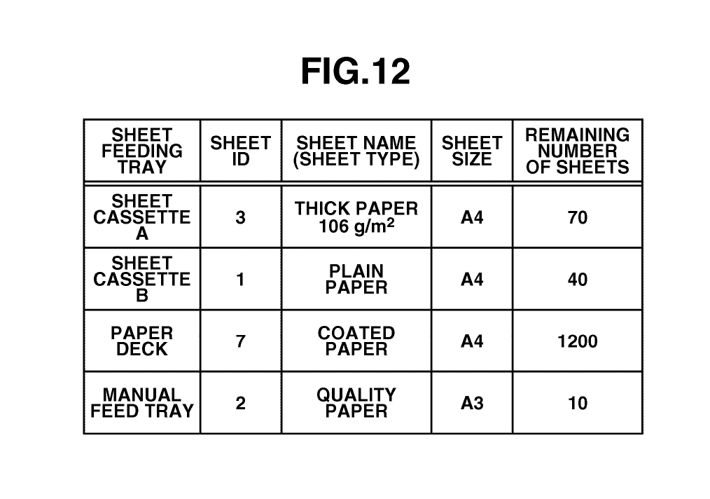

Paper feed tray information illustrated in FIG. 12 is stored in the HDD 209 of the MFP 110.

The paper feed tray information denotes the type (sheet size and sheet type) and amount of sheets stacked on each paper feed tray.

The paper feed tray information stores the following pieces of information of each paper feed tray: sheet ID information about sheet types included in the sheet library information illustrated in FIG. 2, the sheet name corresponding to the sheet ID information, the size of sheets stacked, and the remaining number of sheets stacked. Each of the sheet cassette A 617, the sheet cassette B 618, the paper deck 619, and the manual feed tray 620 is provided with a sensor for detecting the number of sheets stacked. Based on output information from each sensor, the CPU 205 instructs the HDD 209 to store the number of sheets stacked on each paper feed tray as “REMAINING NUMBER OF SHEETS” in FIG. 12.

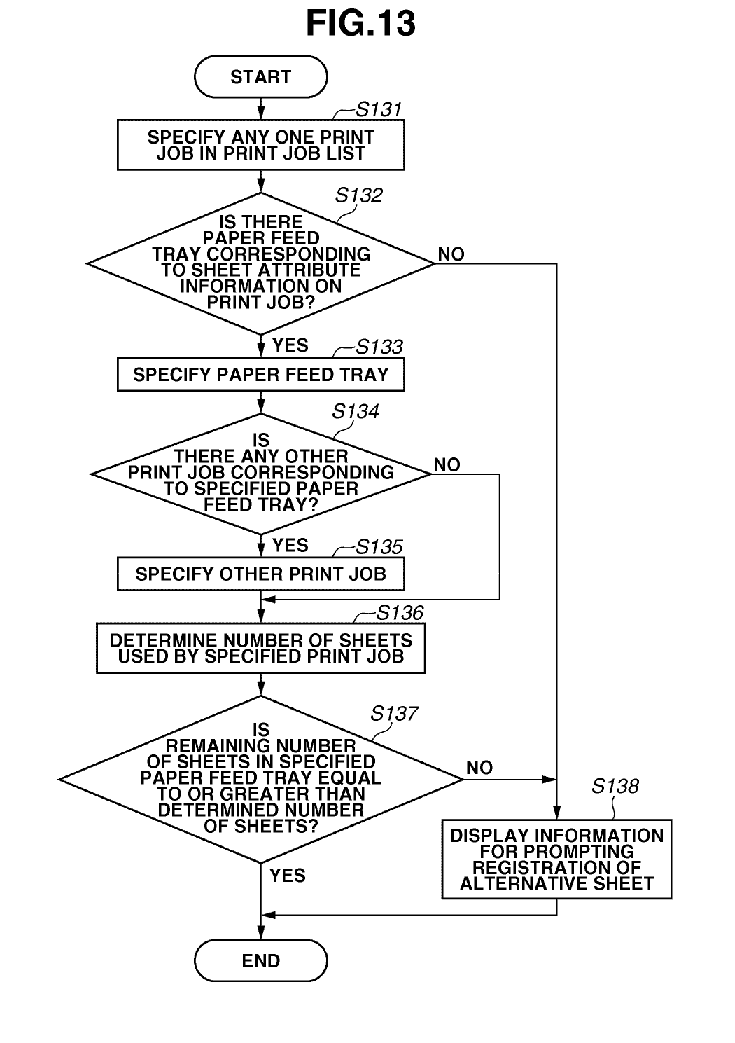

Processing for updating the print job list performed by the CPU 205 of the MFP 110 will be described with reference to the flow chart in FIG. 13.

The CPU 205 performs the processing in FIG. 13 for each of a plurality of print jobs stored under a status of “WAITING FOR PRINTING” in the print job list.

In the processing in FIG. 13, the CPU 205 determines whether the sheet type to be used by each print job is to be changed, based on the number of sheets to be used by each print job and the remaining number of sheets on each paper feed tray of the MFP 110.

In step S131, the CPU 205 identifies any one print job included in the print job list in FIG. 11. Specifically, the CPU 205 identifies a print job waiting for print processing, for example, a job C having a print job ID 003.

In step S132, the CPU 205 determines whether there is any paper feed tray (for example, the sheet cassette B 618) applicable to the sheet attribute information 1004 (for example, sheet type =plain paper, sheet size =A4) for the print job (for example, the job C) identified in step S131. When there is a paper feed tray applicable to the sheet attribute information 1004 (YES in step S132), the processing proceeds to step S133. Otherwise (NO in step S132), the processing proceeds to step S138.

In step S133, the CPU 205 identifies a paper feed tray (for example, the sheet cassette B 618) applicable to the print job (for example, the job C) identified in step S131.

In step S134, the CPU 205 determines whether there is any other print job applicable to the paper feed tray (for example, the sheet cassette B 618) identified in step S133. When there is any other print job applicable to the paper feed tray (YES in step S134), the processing proceeds to step S135. Otherwise (NO in step S134), the processing proceeds to step S136. The other print job is limited to a print job preceding the print job identified in step S131. For example, when the job C is identified in step S131, the other print job is limited to a job B preceding the job C.

In step S135, the CPU 205 identifies other print job (for example, the job B) applicable to the paper feed tray (for example, the sheet cassette B 618) identified in step S133.

In step S136, the CPU 205 determines the total number of sheets to be used by the print jobs (for example, the jobs B and C) identified in steps S131 and S135. This determination is made based on the number of document pages included in the output method specification information 1002, the copy-number specification information 1005, and the document data 1007 for the print jobs. For example, since the job C performs two-sided printing for 10 copies of a 4-page document, it will use 4/2×10=20 sheets. Since the job B performs one-sided printing for one copy of a 30-page document, it will use 30×1=30 sheets. Therefore, these identified jobs will use 20+30=50 sheets.

In step S137, the CPU 205 determines whether the remaining number of sheets in the paper feed tray identified in step S133 is equal to or greater than the number of sheets determined in step S136. When the CPU 205 determines that the remaining number of sheets in the paper feed tray is equal to or greater than the number of sheets (YES in step S137), the processing ends. Otherwise (NO in step S137), the processing proceeds to step S138. For example, suppose the sheet cassette B 618 is identified as a paper feed tray and the number of sheets is determined to be 50 in step S136, the CPU 205 references the paper feed tray information in FIG. 12 and determines that the relevant condition in step S137 is not met (NO) since the remaining number of sheets (40) is smaller than the determined number of sheets (50). Then, the processing proceeds to step S138. This means that the identified paper feed tray (sheet cassette B 618) will run short of sheets before print processing based on the print jobs identified in steps S131 and S135 is completed. In other words, the identified paper feed tray (sheet cassette B 618) may be spent, finished, or be used up to become scanty or insufficient in supply, including falling below a predetermined remaining number of sheets.

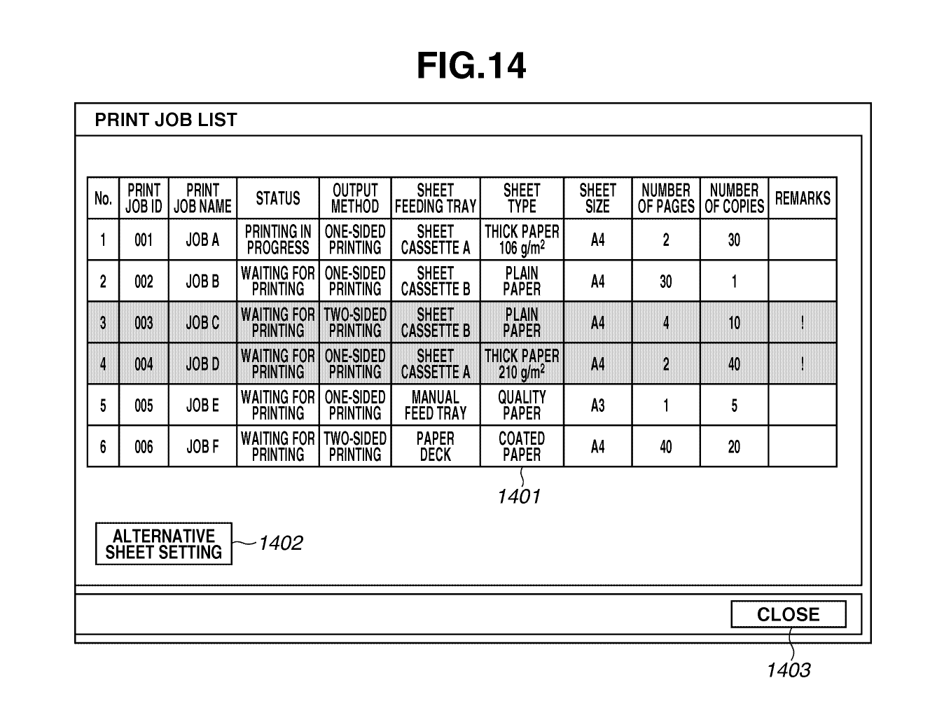

In step S138, the CPU 205 instructs the operation unit 204 to display information for requesting the registration of an alternative sheet, as illustrated in FIG. 14, to change the sheet attribute information 1004 for the print jobs identified in steps S131 and S135.

The print job list displayed on the operation unit 204 in step S138 will be described below with reference to FIG. 14.

FIG. 14 illustrates the print job list in FIG. 11 which is displayed on the operation unit 204. Referring to FIG. 14, a print job list 1401 is displayed so that the jobs C and D can be discriminated from other jobs (jobs A, B, E, and F). The CPU 205 controls the operation unit 204 to display the exclamation mark (!) in the REMARKS column for the jobs C and D so that they can be discriminated from other jobs (jobs A, B, E, and F).

The job C is marked “!” because the CPU 205 completes the following processing based on the flow chart in FIG. 13.

In step S131, identify the job C.

In step S133, identify the sheet cassette B 618.

In step S135, identify the job B.

In step S136, determine that the jobs B and C will use 50 (30+20) sheets.

In step S137, determine that the relevant condition is not met (NO) since the determined number of sheets (50) is greater than the remaining number of sheets (40) in the sheet cassette B 618.

The job D is marked “!” because the CPU 205 completes the following processing based on the flow chart in FIG. 13.

In step S131, identify the job D.

In step S133, identify the sheet cassette A.

In step S135, identify the job A.

In step S136, determine that the jobs A and D will use 140 (60+80) sheets.

In step S137, determine that the relevant condition is not met (NO) since the determined number of sheets (140) is greater than the remaining number of sheets (70) in the sheet cassette B 618.

The jobs A, B, E, and F are not marked “!” on the operation unit 204 because the CPU 205 determined YES in steps S132 and S137.

As mentioned above, in the exemplary present exemplary embodiment, the CPU 205 controls the operation unit 204 to display information for requesting the operator of the MFP to change the sheet attribute information 1004 included in the jobs B and C.

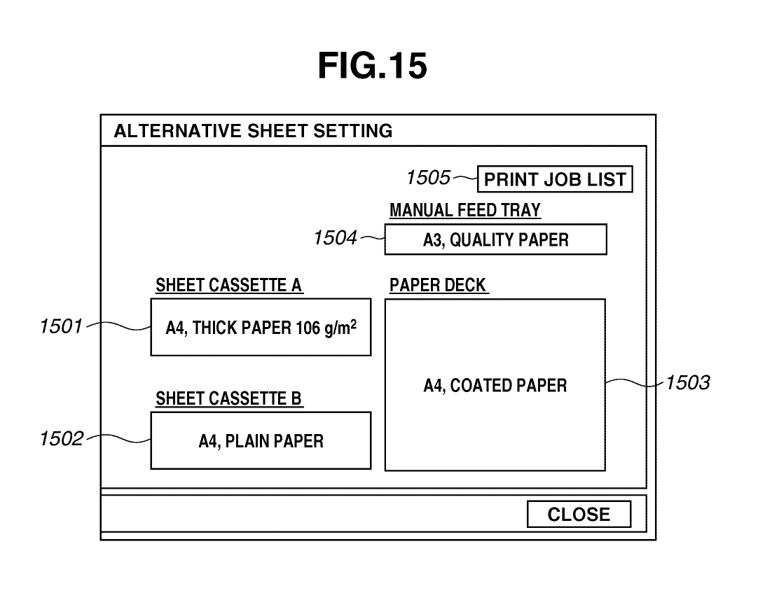

An alternative sheet setting screen will be described below with reference to FIG. 15. The screen in FIG. 15 is displayed when the ALTERNATIVE SHEET SETTING button 1402 in FIG. 14 is accepted in a state where any one print job included in the print job list 1401 in FIG. 14 is selected by an operator's instruction. Although the screen in FIG. 15 is displayed when the ALTERNATIVE SHEET SETTING button 1402 is pressed regardless of which print job included in the print job list 1401 in FIG. 14 is selected, other configurations may be applied. For example, the screen in FIG. 15 may be displayed when the ALTERNATIVE SHEET SETTING button 1402 is accepted only in a state where any one print job marked “!” (in the REMARKS column) is selected in the print job list 1401 in FIG. 14.

Referring to FIG. 15, a button 1501 is used to set the sheet attribute information 1004 (A4-size thick paper 106 g/m2) associated with sheets stacked in the sheet cassette A 617 as the sheet attribute information of the print job selected in FIG. 14.

A button 1502 is used to set the sheet attribute information 1004 (A4-size plain paper) associated with sheets stacked in the sheet cassette B 618 as the sheet attribute information of the print job selected in FIG. 14.

A button 1503 is used to set the sheet attribute information 1004 (A4-size plain paper) associated with sheets stacked in the paper deck 619 as the sheet attribute information of the print job selected in FIG. 14.

A button 1504 is used to set the sheet attribute information 1004 (A3-size quality paper) associated with sheets stacked in the manual feed tray 620 as the sheet attribute information of the print job selected in FIG. 14.

A button 1505 is used to change the alternative sheet setting screen illustrated in FIG. 15 to the print job list screen illustrated in FIG. 14.

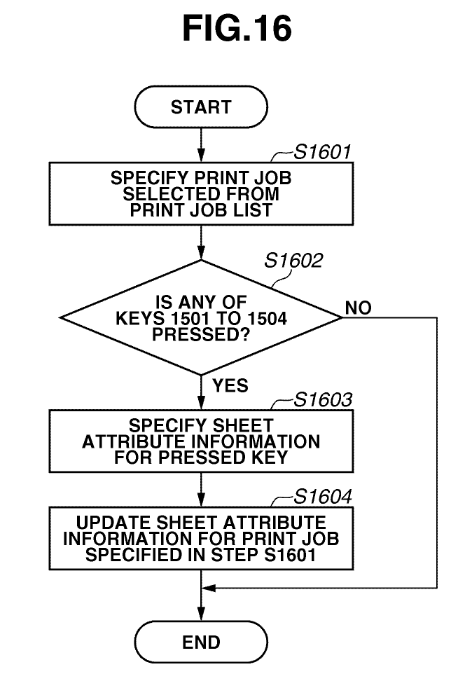

Processing for alternative sheet setting will be described below with reference to FIG. 16. FIG. 16 is a flow chart illustrating processing for alternative sheet setting. This processing is started when the ALTERNATIVE SHEET SETTING button 1402 is accepted in a state where any one of the plurality of print jobs displayed in FIG. 14 is selected.

In step S1601, the CPU 205 determines which print job displayed in the print job list 1401 in FIG. 14 is selected (for example, the job C).

In step S1602, the CPU 205 determines which of the buttons 1501 to 1504 is accepted by the operator of the MFP 110 via the screen (FIG. 15) displayed on the operation unit 204. When the CPU 205 determines that any one key is accepted, the processing proceeds to step S1603. The CPU 205 serves as a means for accepting an operator's instruction.

In step S1603, the CPU 205 identifies the sheet attribute information 1004 associated with the button determined to be accepted in step S1602 based on the paper feed tray information in FIG. 12. For example, when the button 1503 is accepted in step S1602, the CPU 205 identifies the A4 size coated paper (sheet ID=7) stacked in the paper deck 619 as the sheet attribute information.

In step S1604, the CPU 205 updates (overwrites) the sheet attribute information 1004 for the print job identified in step S1601 by using the sheet attribute information 1004 identified in step S1603. For example, when the job C is identified in step S1601 and the A4 size coated paper (sheet ID=7) is identified in step S1603, the CPU 205 changes the sheet attribute information 1004 for the job C from the A4-size plain paper to the A4-size coated paper.

After completion of processing of step S1604, i.e., processing of the flowchart in FIG. 16, when the CPU 205 detects that the button 1505 is accepted in the screen in FIG. 15, it controls the operation unit 204 to display the print job list.

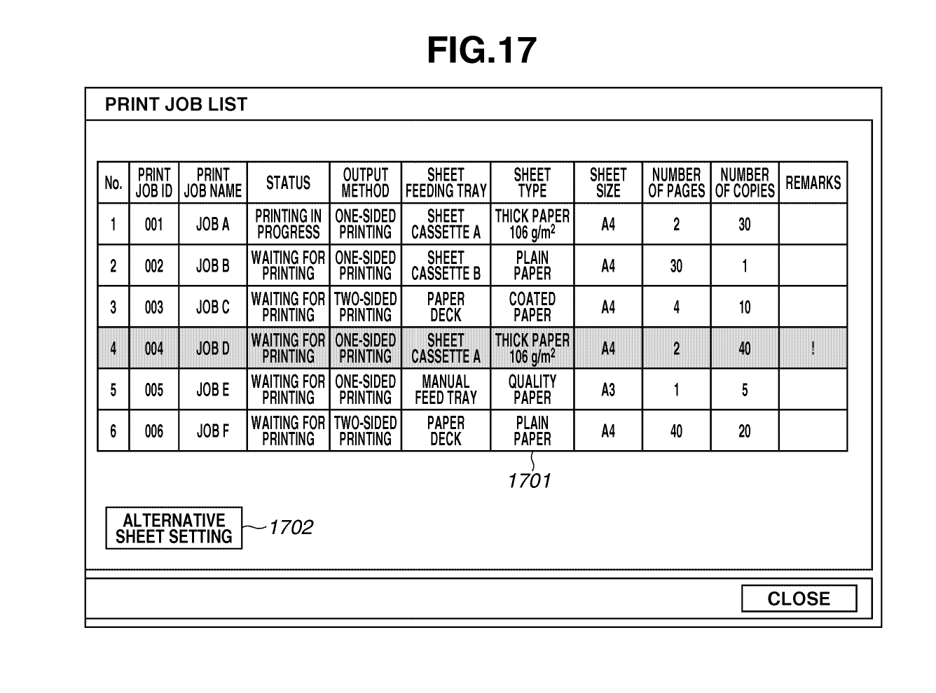

However, as mentioned above, when the sheet attribute information 1004 for the job C is changed via the alternative sheet setting screen in FIG. 15, a print job list 1701 illustrated in FIG. 17 is displayed. The print job list 1701 in FIG. 17 differs from the print job list 1401 in FIG. 14 in that the sheet type of the job C is coated paper (changed from plain paper through alternative sheet setting).

In the print job list 1401 in FIG. 14, the job C is marked “!” for requesting the operator of the MFP 110 to change the sheet attribute information 1004 for the job C. In the print job list 1701 in FIG. 17, the job C is not marked “!.” This is because, as a result of processing of the flow chart in FIG. 13 performed for the job C with which the sheet attribute information 1004 was updated, the CPU 205 determined that the relevant condition is met (YES) in steps S132 and S137. This means that the job C will not run short of coated paper sheets even when the job C and other jobs preceding it are executed. Thus, alternative sheet setting for the job C can prevent print processing from being interrupted when starting or during execution of the job C.

In the print job list 1701 in FIG. 17, since the job D is marked “!”, print processing will be interrupted at the time of starting or during execution of the job D. Similar to the operation performed for the job C, the operator of the MFP 110 can change the sheet attribute information 1004 for the job D by pressing the alternative sheet setting button 1702 in FIG. 17, thus preventing print processing from being interrupted at the time of starting or during execution of the job D.

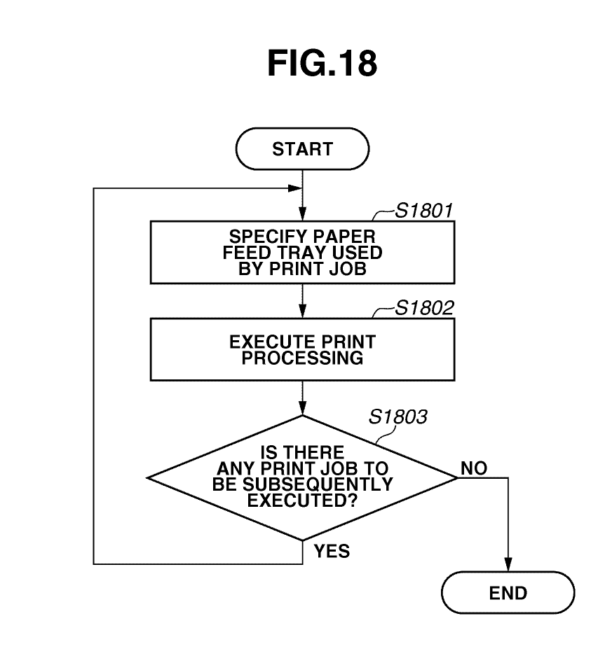

Processing of a print job will be described below with reference to FIG. 18. FIG. 18 is a flow chart illustrating print processing performed when the first job (No. 1) in the print job list in FIG. 11 is executed.

In step S1801, the CPU 205 identifies the paper feed tray to be used by the first job in the print job list. For example, in the print job list in FIG. 11, the CPU 205 identifies the sheet cassette A 617 to be used by the job A.

In step S1802, the CPU 205 performs print processing by feeding a sheet from the paper feed tray identified in identified in step S1802 and using the specified output method. For example, for the job A, the CPU 205 controls the printer unit 203 to feed a sheet from the sheet cassette A 617 and perform one-sided print processing.

In step S1803, the CPU 205 references the print job list in FIG. 11, determines whether there is any print job to be subsequently executed. When there is a print job to be subsequently executed (YES in S1803), the processing returns to step S1801 to execute the subsequent print job. Otherwise, when there is no print job to be subsequently executed (NO in step S1803), the processing of the flow chart in FIG. 18 ends.

According to the above-mentioned first exemplary embodiment, even when a specific print job will run short of sheet at the time of execution, it is possible to request the operator to give an instruction for enabling execution of the specific print job and receive the operator's instruction, thus preventing print processing from being interrupted at the time of starting or during execution of the specific print job.

A second exemplary embodiment will be described below. In the first exemplary embodiment, only one type of sheet attribute information is set in each of the jobs A to F.

In the second exemplary embodiment, on the other hand, a plurality of types of sheet attribute information is set in one print job. The second exemplary embodiment is a modification of the first exemplary embodiment and therefore similar to the first exemplary embodiment unless otherwise described below.

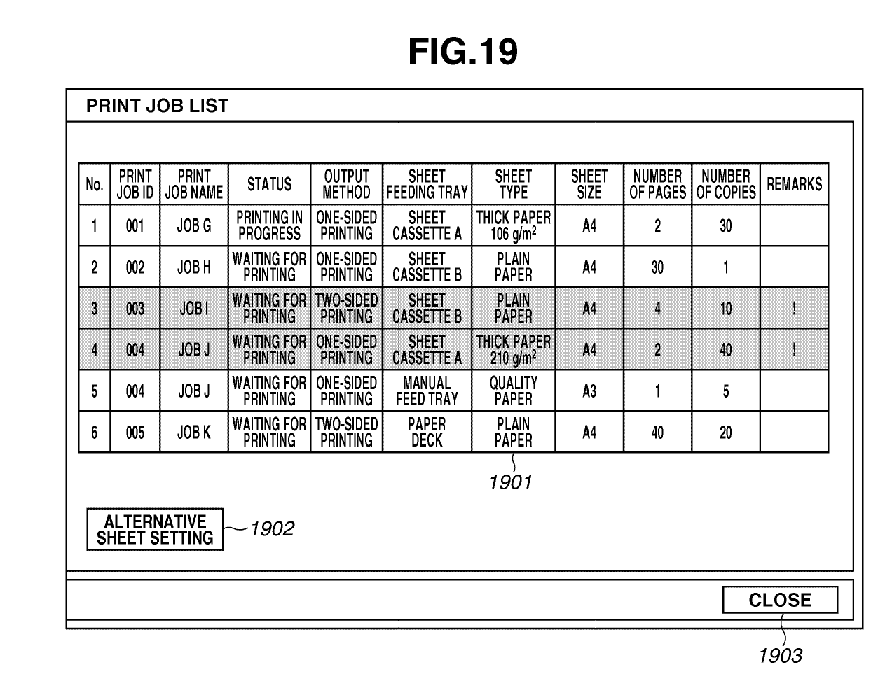

FIG. 19 describes a print job list 1901 according to the second exemplary embodiment. The print job list 1901 in FIG. 19 differs from the print job list 1401 in FIG. 14 according to the first exemplary embodiment in that a plurality of types of sheet attribute information is set in one print job. Specifically, referring to FIG. 19, print job Nos. 4 and 5 are assigned the same print job ID (004) meaning that they denote one print job (a job J). In other words, although the job J is one print job, it performs print processing by using two different sheet types: A4-size thick paper 106 g/m2 and A4-size quality paper.

Even when the sheet attribute information associated with a plurality of sheet types is set in one print job, the CPU 205 of the MFP 110 requests the operator to give an instruction for enabling execution of a specific print job in a similar way to the first exemplary embodiment.

Processing for updating the print job list (FIG. 13) performed for the job J will be described below. The CPU 205 identifies the job J in step S131 and determines that the relevant condition is met (YES) in step S132.

In step S133, the CPU 205 identifies the sheet cassette A 617 and the manual feed tray 620 as paper feed trays to be used by the job J.

In step S134, the CPU 205 determines whether there is any other print job preceding the job J, which uses the sheet cassette A 617 or the manual feed tray 620. In step S135, the CPU 205 identifies a job G as other print job. In step S136, the CPU 205 determines that the job J will use 80 sheets of A4-size thick paper 106 g/m2 and 5 sheets of A3-size quality paper. The CPU 205 also determines that the job G will use 60 sheets of A4-size thick paper 106 g/m2.

In step S137, the CPU determines that the relevant condition is not met (NO) since the number of sheets of A4-size thick paper 106 g/m2 to be used by the jobs J and G (80+60) is greater than the remaining number of sheets of A4-size thick paper 106 g/m2 (70) illustrated in FIG. 12. In step S138, the CPU 205 controls the operation unit 204 to display information for requesting the operator to select any other sheet type as an alternative sheet for A4-size thick paper 106 g/m2.

Similar to the first exemplary embodiment, A4-size thick paper 106 g/m2 can be changed to A4-size coated paper via the alternative sheet setting screen in FIG. 15 displayed when the alternative sheet setting button 1902 is accepted. In this case, the sheet attribute information of the job J has been changed, and the CPU 205 controls the operation unit 204 not to display the “!” mark for requesting selection of an alternative sheet type, displayed in the print job list 1901 in FIG. 19.

According to the above-mentioned second exemplary embodiment, even when a specific print job having the sheet attribute information of a plurality of sheet types will run short of sheets at the time of execution, it is possible to request the operator to give an instruction for enabling execution of the specific print job and receive the operator's instruction, thus preventing print processing from being interrupted at the time of starting or during execution of the specific print job.

Although, in the first and second exemplary embodiments, a sensor provided at each paper feed tray detects the remaining number of sheets, other configurations may be applied.

For example, a sensor provided at each paper feed tray may output to the CPU 205 information about the remaining number of sheets in percentage assuming that the maximum number of sheets is 100%. In this case, the CPU 205 presumes the number of sheets stacked in each paper feed tray based on the output information, and stores in the HDD 209 the presumed value as the remaining number of sheets.

It is also possible that the operator of the MFP 110 inputs via the operation unit 204 the number of sheets to be stacked in each paper feed tray, and, each time a sheet is fed from each paper feed tray, the input number of sheets is decremented and stored in the HDD 209 as the remaining number of sheets.

Although, in the first and second exemplary embodiments, the CPU 205 determines that the relevant condition is not met (NO) when the remaining number of sheets in the paper feed tray identified in step S137 is smaller than (falls below) the determined number of sheets, other configurations may be applied. For example, it is possible that a predetermined remaining number of sheets (for example, 10) is subtracted from the remaining number of sheets in the identified paper feed tray, and the CPU 205 determines that the relevant condition is not met (NO) when the resultant value is smaller than the determined number of sheets.

### Other Embodiments

Aspects can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In an example, a computer-readable medium may store a program that causes a printing apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-064319 filed Mar. 19, 2010, which is hereby incorporated by reference herein in its entirety.

What is claimed is:

1. A printing apparatus, comprising:
an input unit configured to input a print job including attribute information of a sheet to be used for print processing;
a holding unit configured to hold the print job input by the input unit;
a printing unit configured to execute the print job held by the holding unit to perform print processing for the sheet;
a plurality of sheet stacking units configured to stack sheets to be used for the print processing;
a storage unit configured to store each of the plurality of sheet stacking units in association with attribute information of sheets stacked in the plurality of sheet stacking units;
a sheet feeding unit configured to feed a sheet to be used by the printing unit when executing a specific print job included in a plurality of print jobs held by the holding unit, from a specific sheet stacking unit stored in the storage unit in association with the attribute information included in the specific print job;
a detection unit configured to detect a remaining number of sheets stacked in each of the plurality of sheet stacking units;
a determination unit configured to determine whether the remaining number of sheets stacked in the specific sheet stacking unit will run short by finishing the specific print job based on an amount of sheets stacked in the specific sheet stacking unit to be used by the specific print job and other print jobs preceding the specific print job;
a request unit configured to request, when the determination unit determines that the remaining number of sheets stacked in the specific sheet stacking unit will run short by finishing the specific print job, an operator's instruction for changing the sheet attribute information included in the specific print job to other sheet attribute information;
a receiving unit configured to receive an operator's instruction for changing the sheet attribute information included in the specific print job to other sheet attribute information; and
a control unit configured to perform, when the receiving unit receives the operator's instruction, control for changing the sheet attribute information included in the specific print job stored in the storage unit.

2. The printing apparatus according to claim 1, wherein the determination unit determines that the remaining number of sheets stacked in the specific sheet stacking unit will run short in a case where the remaining number will be zero by finishing the specific print job.

3. The printing apparatus according to claim 1, wherein the attribute information of the sheet includes sheet size information denoting a size of the sheet.

4. The printing apparatus according to claim 1, wherein the attribute information of the sheet includes sheet type information denoting a type of the sheet.

5. A method for controlling a printing apparatus, wherein the printing apparatus includes an input unit configured to input a print job including attribute information of a sheet to be used for print processing, a holding unit configured to hold the print job input by the input unit, a printing unit configured to execute the print job held by the holding unit to perform print processing for the sheet, a plurality of sheet stacking units configured to stack sheets to be used for the print processing, and a storage unit configured to store each of the plurality of sheet stacking units in association with attribute information of sheets stacked in the plurality of sheet stacking units, the method comprising:
feeding a sheet to be used by the printing unit when executing a specific print job included in a plurality of print jobs held by the holding unit, from a specific sheet stacking unit stored in the storage unit in association with the attribute information included in the specific print job;
detecting a remaining number of sheets stacked in each of the plurality of sheet stacking units;
determining whether the remaining number of sheets stacked in the specific sheet stacking unit will run short by finishing the specific print job based on an amount of sheets stacked in the specific sheet stacking unit to be used by the specific print job and other print jobs preceding the specific print job;
requesting, when it is determined that the remaining number of sheets stacked in the specific sheet stacking unit will run short by finishing the specific print job, an operator's instruction for changing the sheet attribute information included in the specific print job to other sheet attribute information;
receiving an operator's instruction for changing the sheet attribute information included in the specific print job to other sheet attribute information; and
performing, when the operator's instruction is received, control for changing the sheet attribute information included in the specific print job stored in the storage unit.

6. The method for controlling the printing apparatus according to claim 5, wherein determining that the remaining number of sheets stacked in the specific sheet stacking unit will run short in a case where the remaining number will be zero by finishing the specific print job.

7. The method for controlling the printing apparatus according to claim 5, wherein the attribute information of the sheet includes sheet size information denoting a size of the sheet.

8. The method for controlling the printing apparatus according to claim 5, wherein the attribute information of the sheet includes sheet type information denoting a type of the sheet.
